(19) United States
(12) Patent Application Publication
(10) Pub. No.: US 2003/0196343 A1
(43) Pub. Date: Oct. 23, 2003

(54) Measurement module

(76) Inventors: Michael Abraham, Mainz (DE); Oliver Depner, Saulheim (DE); Dietrich Drews, Selzen (DE); Michael Schweiger, Orlamunde (DE)

Correspondence Address: HUDAK, SHUNK & FARINE CO. LPA, Daniel J. Hudak, Jr., 2020 Front Street, Suite 307, Cuyahoga Falls, OH, 44221, US

(21) Appl. No.: 10/408,890

(22) Filed: Apr. 8, 2003

(30) Foreign Application Priority Data
Apr. 11, 2002 (DE) 102 17 028.2-33

(51) Int. Cl. G01D 21/00

(52) U.S. Cl. 33/645

(57) ABSTRACT

A measurement module for measuring particularly the surface of wafers is described, which comprises a measuring device and a measuring table that has a wafer table equipped with a rotary drive. The design of this measurement module should be as compact as possible. To this end, the wafer table (10) is cup-shaped with at least one support edge (13, 14) for a wafer (4, 4a, 4b), which is provided with an adhesive material. A wafer aligning device (30) is arranged in the interior of the wafer table (10). A displaceable measuring head (7) in which a measuring device and a notch detector are integrated is disposed above the wafer table.

The invention relates to a measurement module for wafer production systems in accordance with the preamble of claim 1. Such a measurement module is disclosed, for instance, in U.S. Pat. No. 5,822,213.

For quality control in the manufacture of semiconductor chips, particularly the manufacture of wafers with a diameter of 300 mm, so-called integrated measurement techniques are increasingly used. In integrated measurement techniques, unlike in conventional stand-alone measurement techniques, the measuring device is directly connected to, and integrated in, the production line. This is to ensure that quality control is as close as possible to the process.

The integration of measurement techniques in the process units is often highly complex, as it frequently requires modifications in both systems, i.e. in the process units and in the measurement systems, which in turn is connected with additional costs.

In 300-mm wafer technology, however, a high degree of standardization is found. The process equipment is provided with so-called Equipment Front End Modules (EFEMs). The EFEM represents the interface between the chip factory and the process equipment and takes care of logistics, i.e. the automatic supply of the plant with wafers. The EFEMs typically have at least two load ports, the dimensions of which are standardized. The wafer containers (Front Opening Unified Pods or FOUPs), which hold the wafers, are placed onto these load ports.

The EFEM further includes a robot and at the back is coupled to the corresponding process equipment. The EFEM comprises a wafer container (FOUP) and transports the wafers into the process equipment by means of a further robot via a lock, and after processing delivers the wafers to another FOUP.

In principle, an EFEM can also have several load ports. These load ports can be readily interchanged. The EFEM is thus an ideal location for coupling a measurement device with a process unit, since it enables the use of the existing logistics of the EFEM with robots to allow flexible integration of the measuring process in the production process.

Integrated measurement techniques make it possible to subject the wafer to an input measurement prior to processing and a final inspection after processing. This makes it possible to avoid further processing of bad wafers and to return the system to the predefined process windows if divergent parameters are detected.

A prerequisite for integrating measuring systems in such production units, however, is that the measuring equipment is not wider or deeper than a load port and thus meets the standard dimensions defined in SEMI Standard No. E 15.

In the prior-art measuring equipment, the wafers are rotated during measurement. During this process, the wafer is usually supported on a wafer table that is equipped with a rotary drive.

To avoid uncontrolled shifting during rotation, the wafer must be fixed. A vacuum suction system may be used for this purpose, which pulls the wafer flat on a very plane surface. This also produces a high degree of planarity of the wafer, which is required for accurate measurement. Vacuum suction systems, however, have the drawback that the contact can cause contamination on the rear side of the wafer, which can reduce the yield.

Attempts have therefore been made to replace such systems with other devices. However, the elimination of vacuum suction systems presumes that the position and the distance of the wafer do not have a negative influence on the measurement of the wafer, or that the measuring head automatically corrects its position, as it is described, for instance in DE 198 16 974. This makes it possible to dispense with an active alignment of the wafer table and the planarization by means of a complex vacuum suction system to save costs and weight. As a result it is possible to use wafer holding systems that grasp the wafer only along its periphery. These are so-called edge gripping systems, which are provided with rollers to roll the wafer along its edges. The drawback of these systems, however, is that abrasive wear on the friction rollers can produce particulates that should be avoided in semiconductor production.

Such edge gripping systems are also used to align the wafers. These are self-contained units, referred to as notch aligners, which align the wafer by means of its recess or notch in the wafer edge. Before such an alignment is possible, the position of the wafer and that of its notch must be determined, which requires an additional device called a notch aligner. With the notch detector and the notch aligner, the coordinate systems of the wafer and the measuring system are aligned, so that the measurements can subsequently be carried out at precisely determined locations of the wafer. A notch aligner is disclosed, for instance, in U.S. Pat. No. 5,102,280.

U.S. Pat. No. 5,822,213 discloses a notch detector that comprises a laser diode above the wafer. A ribbon-shaped light beam is produced by means of a lens system and directed onto the edge of the wafer, with a portion of the light ribbon being shielded by the wafer edge. Under the wafer, there is a detector that measures the intensity of the portion of the light ribbon that passes by the edge of the wafer. Based on the intensity curve over a 360° revolution of the wafer, it is possible to determine the orientation and the position of the center of the wafer as well as the position of the notch. This is a separate station that requires a large amount of space because of the arrangement of the laser and the detector.

The object of the invention is to provide a compact measurement module by means of which the wafer to be measured can be fixed on the wafer table in a simple manner and which eliminates the need for an additional station for determining the position and the alignment of the wafer.

This object is attained by a measurement module, which is characterized in that the wafer table is cup-shaped and has at least one support edge for a wafer which is provided with an adhesive material, that a wafer aligner is arranged in the interior of the wafer table, and that a displaceable measuring head integrating a measuring device and a notch detector is disposed above the wafer table.

The adhesive material has the advantage that no additional space-consuming holding devices are required to fix the wafer on the wafer table. Preferably, an adhesive material is used that does not chemically contaminate or mechanically damage the wafer, or cause abrasion.

The adhesive friction of the adhesive material is preferably adapted to the wafer material. The adhesive friction must be high enough to make sure that the wafer adheres securely during rotation. On the other hand, adhesion may not be so strong that it becomes difficult to remove the wafer, e.g. by a robot.

The magnitude of the adhesive friction can be adjusted by means of the length and the width of the surface of the adhesive material.

At least one strip of adhesive material can be fixed to the support edge. The adhesive friction is adjusted precisely via the length of the strip, which can be formed as an annular strip or an annular segment.

The adhesive material is preferably elastic, so that the wafer surface is not mechanically damaged during placement.

The adhesive material is preferably a perfluoroelastomer. Examples of perfluoroelastomers are the products Kalrez® of 3M or Chemraz® of Green Tweed.

The wafer table has preferably at least two support edges that are offset in height. For instance, in addition to an outer support edge, a lower inner support edge may be provided, so that differently sized wafers, e.g. having a diameter of 200 or 300 mm can be deposited on the wafer table.

The support edge has preferably a cutout in the edge area, to provide an engagement means for a handling system, e.g. a robot that deposits the wafer on the wafer table or removes it therefrom.

The cup-shaped configuration of the wafer table has the advantage that a wafer alignment device can be arranged in the interior of the wafer table. In a preferred embodiment, this is a vertically displaceable and rotatable wafer lifter that is arranged in the rotational axis of the wafer table. For this purpose, the wafer table is preferably equipped with a hollow shaft that receives the axis of the wafer lifter.

The drive mechanism of the wafer lifter is preferably coupled with a control device that is connected to the notch detector.

The notch detector preferably comprises a laser and a photodetector that detects the light reflected from the wafer surface. Since the reflected light is analyzed, both the laser and the photodetector can be integrated in the measuring head to create a space-saving arrangement.

The laser preferably emits a ribbon-shaped beam that is directed onto the edge of the wafer.

Exemplary embodiments of the invention will now be described in greater detail with reference to the drawings in which

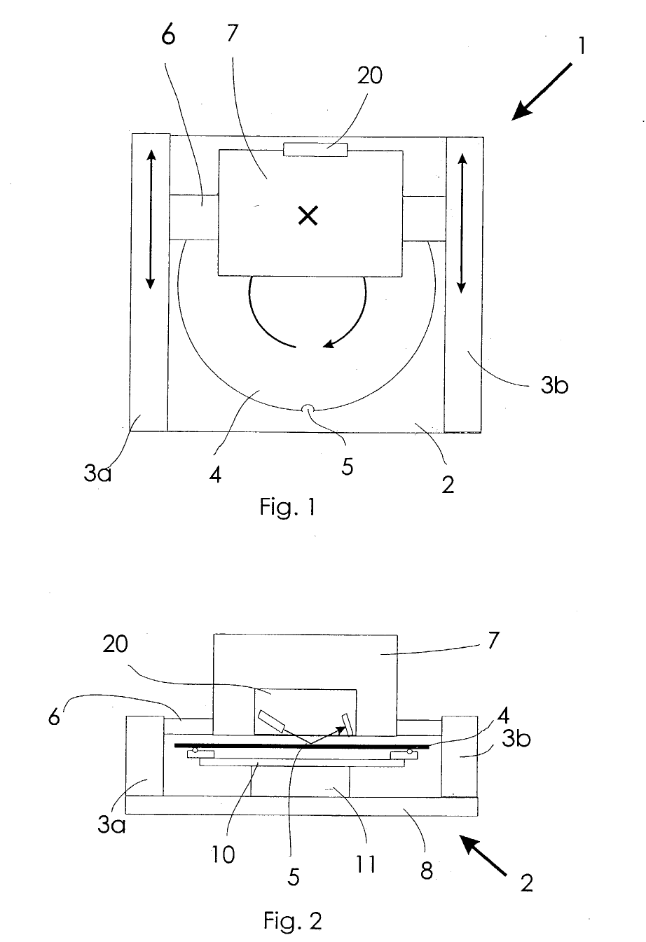

FIG. 1 is a top view of a measurement module,

FIG. 2 is a side view of the measurement module depicted in FIG. 1,

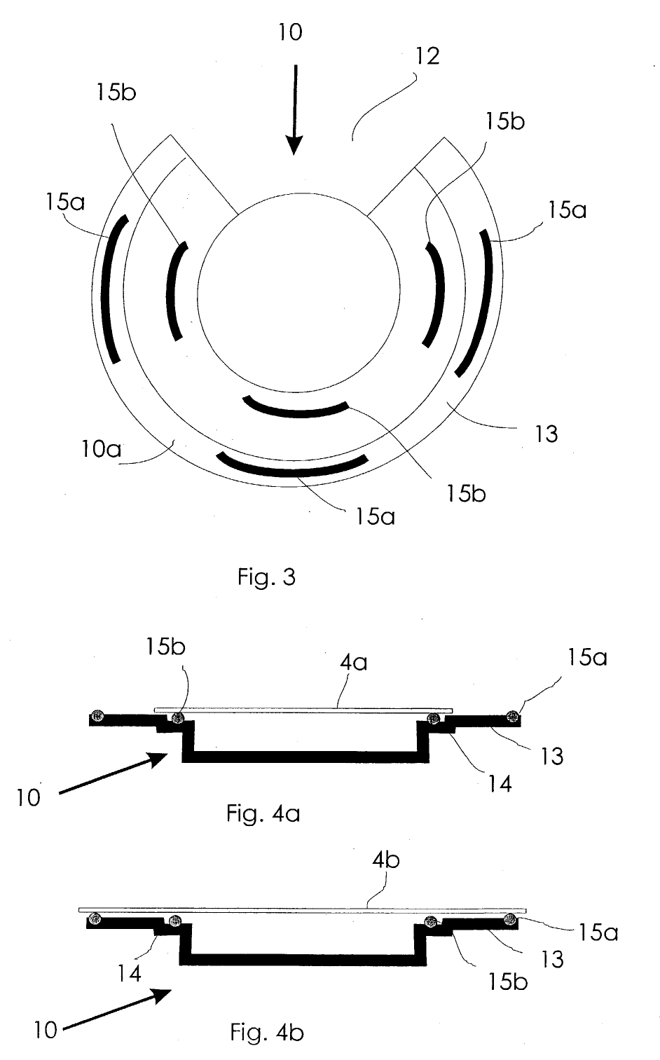

FIG. 3 is a top view of a wafer table,

FIGS. 4a, b are sections through a wafer table with two wafers of different diameters.

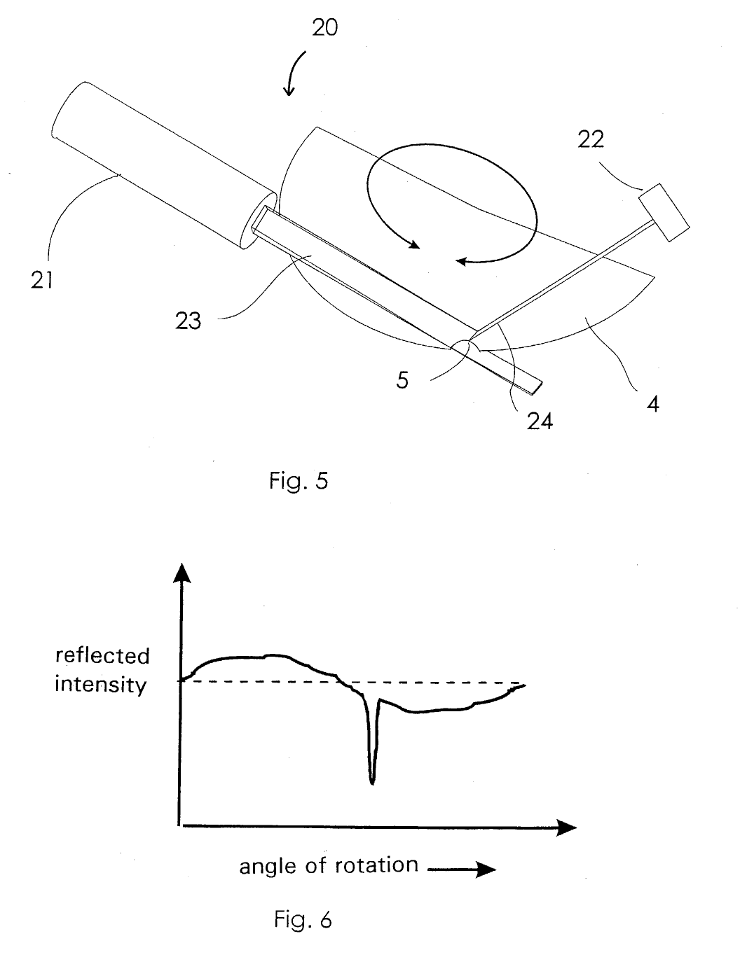

FIG. 5 depicts a notch detector,

FIG. 6 shows the intensity curve of the light beam reflected by the notch detector, and

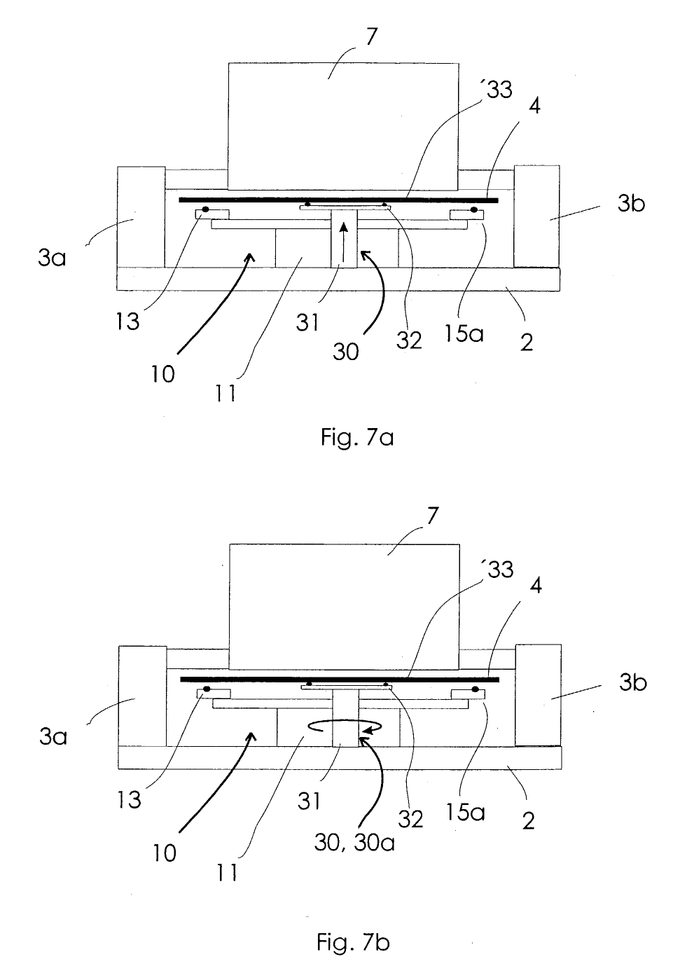

FIGS. 7a, b show a measurement module with a wafer lifter.

FIG. 1 is a top view of a measurement module 1 comprising a measuring table 2 and a measuring head 7. The measuring table 2—as shown in FIG. 2—has a base plate 8 carrying a rotary motor 11 with a wafer table 10 on which a wafer 4 is placed. The wafer 4 has a notch 5 and during the measurement is rotated in the direction of the arrow by means of the wafer table 10 (see FIG. 1).

Two linear motors 3a, 3b that are interconnected by a support 6 are arranged on two sides of the wafer table 10. On the support 6, a measuring head 7 is arranged, which can thus be displaced in a linear motion during the measurement. The measuring head 7 comprises a measuring device (not depicted) and a notch detector 20 that will be described in greater detail in connection with FIGS. 5 and 6.

The following devices can be used as measuring devices:

Spectrometer for measuring layer thicknesses and layer compositions,

FTIR spectrometer (Fourier Transform Infrared Spectrometer) for measuring contamination,

Ellipsometer for measuring layer thicknesses,

Microscope for measuring lateral structures as well as defects,

Stray light measuring devices for measuring particulates and other defects,

Atomic force microscope.

Such miniaturized measuring devices are known, for instance from U.S. Pat. No. 6,091,499 and U.S. Pat. No. 5,502,567.

FIG. 3 is a top view of the wafer table 10, which has a sector-shaped cutout 12. Consequently, the wafer table 10 has a table sector 10a. The cutout 12 serves as an engagement means for a robot arm.

On the table sector 10a, the wafer table 10 is provided with two annular support edges 13, 14, each of which is equipped with several adhesive strips 15a, 15b.

FIGS. 4a and 4b each show a section through a wafer table 10, so that the cup-shaped configuration is visible. The wafer table 10 has two annular support edges 13 and 14 that are offset in height. Strips 15a and 15b of an adhesive material are fixed to these two annular support edges 13 and 14. Because the support edges 13 and 14 are offset in height, wafers with a diameter of e.g. 200 mm can be deposited on the inner annular support edge 14 and wafers 4b with a diameter of e.g. 300 mm on the annular support edge 13. This allows a flexible use of the wafer table 10. The automatic adjustment system contained in the measuring head and described, for example, in DE 198 16 974.4, ensures that the working distance required for each wafer type is automatically established.

FIG. 5 shows an enlarged view of the notch detector 20. The wafer 4 has a notch 5, which is illuminated by means of a laser 21. A ribbon-shaped laser beam 23, which is directed at the edge area of the wafer 4, is used for this purpose. 24 identifies the reflected beam and 22 the associated detector in the form of a photodiode. During rotation of the wafer 4, a portion of the ribbon-shaped laser beam 23 is reflected by the wafer surface, the intensity of which drops abruptly when it reaches the notch 5, as illustrated in FIG. 6. A 360° periodic signal is obtained whose period and phase position provide information on the position of the center of the laser relative to the axis of rotation of the wafer table. An abrupt dip caused by the passage of the notch 5 is superimposed on the periodic signal. This signal and the associated signal of an angle transmitter (not depicted) make it possible to determine the position of the notch.

FIGS. 7a and 7b depict the wafer aligning device 30 associated with the notch detector 20. A lifter support 31 with a lifter table 32 mounted thereon is arranged in the center of the cup-shaped wafer table 10. The lifter table 32 also has a support 33 of adhesive material on which the wafer rests in its lifted state. By rotating this wafer lifter 30a,the wafer 4 can be aligned using the information supplied by the notch detector and subsequently deposited again on the annular support edge 13.

As shown here, the wafer lifter 30 can consist of a simple lifting system and can be equipped, for example, with a moving coil drive unit or a stepper motor. The wafer table 10 itself is preferably equipped with a hollow shaft to receive the wafer lifter 30.

### List of Reference Numerals

1 measurement module

2 measuring table

3a, b linear motor

4 wafer

4a, b wafer

5 notch

6 support

7 measuring head

8 base plate

10 wafer table

10a table sector

11 rotary motor

12 sector-shaped cutout

13 annular support edge

14 annular support edge

15a, b adhesive strips

20 notch detector

21 laser

22 photodiode

23 ribbon-shaped laser beam

24 reflected laser beam

30 wafer alignment device

30a wafer lifter

31 lifter support

33 elastic support

1. Measurement module for measuring particularly the surface of wafers, comprising a measuring device and a measuring table that has a wafer table equipped with a rotary drive, characterized in that the wafer table (10) is cup-shaped and has at least one support edge (13, 14) for a wafer (4, 4a, 4b), which is provided with an adhesive material, that in the interior of the wafer table (10) a wafer alignment device (30) is arranged, and that over the wafer table, a displaceable measuring head (7) is arranged in which a measuring device and a notch detector (20) are integrated.

2. Measurement module as claimed in claim 1, characterized in that the adhesive friction of the adhesive material is adjusted to the material of the wafer (4, 4a, 4b).

3. Measurement module as claimed in either one of claim 1 or 2, characterized in that the magnitude of the adhesive friction is adjusted via the length and the width of the surface of the adhesive material.

4. Measurement module as claimed in any one of claims 1 to 3, characterized in that the adhesive material is elastic.

5. Measurement module as claimed in any one of claims 1 to 4, characterized in that the adhesive material is a perfluoroelastomer.

6. Measurement module as claimed in any one of claims 1 to 5, characterized in that at least one strip (15a, b) of the adhesive material is fixed to the support edge.

7. Measurement module as claimed in any one of claims 1 to 6, characterized in that the wafer table (10) has at least two support edges (13, 14) that are offset in height.

8. Measurement module as claimed in any one of claims 1 to 7, characterized in that the support edge (13, 14) has at least one cutout (12) in the edge area.

9. Measurement module as claimed in any one of claims 1 to 8, characterized in that the wafer alignment device (30) has a vertically displaceable and rotatable wafer lifter (30a) that is arranged in the axis of rotation of the wafer table (10).

10. Measurement module as claimed in claim 9, characterized in that the drive unit of the wafer lifter (30a) is coupled with a control unit that is connected to the notch detector (20).

11. Measurement module as claimed in any one of claims 1 to 10, characterized in that the notch detector (20) comprises a laser (21) and a photodetector (22) that detects the light reflected from the wafer surface.

12. Measurement module as claimed in claim 11, characterized in that the laser (21) emits a ribbon-shaped beam (23).
